(19) United States
(12) Patent Application Publication
(10) Pub. No.: US 2010/0098399 A1
(43) Pub. Date: Apr. 22, 2010

(54) High intensity, strobed led micro-strip for microfilm imaging system and methods

(76) Inventors: Kurt Breish, Garden Valley, ID (US); Dennis R. Sand, Garden City, ID (US); Jeffrey A. Wrede, Eagle, ID (US)

Correspondence Address: GERALD B ROSENBERG;NEW TECH LAW, 260 SHERIDAN AVENUE, SUITE 208, PALO ALTO, CA, 94306-2009, US

(21) Appl. No.: 12/288,226

(22) Filed: Oct. 17, 2008

(51) Int. Cl. G03B 15/03; H05B 41/36; F21V 11/00

(52) U.S. Cl. 396/155; 315/360; 362/355

(57) ABSTRACT

A light source, suitable for use in a high-speed, continuous transport microfilm imaging system, includes an LED emitter element thermally coupled to a heat sink and is mounted within a light source housing. A light output opening in the light source housing, further defined by a narrow width light transfer channel, defines a narrow width active illumination area on the microfilm media. An optical diffusion plate, providing for a randomized directional distribution of light emitted by the LED emitter element, is mounted within the light source housing in an optical path extending between the light output opening and the LED emitter element. A switched current source is coupled to the LED emitter element to enable strobed operation synchronous with the periodic operation of a line imaging camera. The LED emitter element can be construed as a linear micro-strip array of LED elements. A cylindrical lens can be place in the optical path between the LED emitter element and diffusion plate to narrow and increase the intensity of light incident on and transmitted through the diffusion plate.

### BACKGROUND OF THE INVENTION

1. Field of the Invention

The present invention is generally related to microfilm imaging systems and, in particular, to a high-speed microfilm imaging system utilizing a compact, high-intensity LED micro-strip light source strobed synchronous with a line-scan imaging camera.

2. Description of the Related Art

Microfilm imaging systems are conventionally used for the high-speed transfer of microfilm documents in existing library archives to a digital image format. Existing microfilm scanning systems implement various film media transport systems and utilize high capture rate digital cameras. Rather than image an entire two-dimensional frame at a time, some microfilm imaging systems implement a continuous motion transport system and image a series of one-dimensional line exposures typically oriented transverse to the media transfer path. The line exposures are captured and transferred into data buffers for processing, typically by a digital computer, appropriate to reconstruct the individual images of the archived documents.

Imaging accuracy is dependent on a number of factors, including the microfilm transfer speed, the number of line exposures captured per frame, and the line exposure time. In conventional continuous scanning systems, transport speeds may potentially range from about 0.5 to more than 15 inches per second (IPS). Higher speeds are desirable. Minimum acceptable image resolutions, in terms of transverse exposure lines, is dependent on a number of media and transport speed related factors, but are typically between about 2,500 and 15,500 lines per inch. Increased exposure lines per inch are desirable. Conventional cameras, typically implemented using standard CCD arrays, are typically operated at rates of about 2,000 to about 10,000 exposures per second.

A principal limiting factor on camera speed is the exposure illumination required for full speed operation. As camera speed increases, the illumination must be increased proportionally for accurate image capture by the CCD array. In conventional microfilm scanning systems, a high-power, projector-type incandescent light source is placed to backlight the microfilm within a camera imaging path. For moderate to high speed systems, 100 to more than 150 watt incandescent bulbs are used. Even at the lowest wattage, an infrared (IR) filter is required between the incandescent bulb and microfilm to avoid thermal distortion or damage of the exposed microfilm. Perhaps more significant, exposure to IR will saturate, or blind, conventional CCD camera elements.

In addition to the IR filter, conventional incandescent light sources require use of a color corrected lens to achieve reasonable focal clarity and, correspondingly, reasonable reproduction quality in the acquired images. The illumination produced by conventional incandescent light sources is broadband, therefore requiring color dependent refractive correction by the lens. Broadband color corrected lenses are, unfortunately, relatively expensive.

### SUMMARY OF THE INVENTION

Thus, a general purpose of the present invention is to provide an efficient, high-intensity light source well-tailored for use in microfilm imaging systems.

This is achieved in the present invention by providing a light source, suitable for use in a high-speed, continuous transport microfilm imaging system, that includes an LED emitter element thermally coupled to a heat sink and is mounted within a light source housing. A light output opening in the light source housing, further defined by a narrow width light transfer channel, defines a narrow width active illumination area on the microfilm media. An optical diffusion plate, providing for a randomized directional distribution of light emitted by the LED emitter element, is mounted within the light source housing in an optical path extending between the light output opening and the LED emitter element. A switched current source is coupled to the LED emitter element to enable strobed operation synchronous with the periodic operation of a line imaging camera. The LED emitter element can be construed as a linear micro-strip array of LED elements. A cylindrical lens can be placed in the optical path between the LED emitter element and diffusion plate to narrow and increase the intensity of light incident on and transmitted through the diffusion plate.

An advantage of the present invention is that the light source is highly efficient in that the light strip produces a narrow-band emission spectrum that is closely matched to the sensitivity band of the CCD elements. Spectrum filtering, and associated loss of light power, is not required. Further, the light strip produces no meaningful IR emissions. Any generated IR is too attenuated to reach and affect the CCD imager. An IR filter is not required.

Another advantage of the present invention is that the light source can be strobed synchronous with the exposure period of the CCD imager. The illumination cycle edges are sharp with repeatable characteristics and the illumination intensity is highly uniform. The intensity level can be set to different specific levels, enabling adaptation to different operating factors including media transport speed, desired imaging resolution, contrast range, and various aspects of a specific microfilm media. The power requirements and heat-generation by the light source are therefore minimized in alignment with the specific illumination needs of the imager.

A further advantage of the present invention is that a higher specific illumination intensity is achieved during the required duration of an imager exposure cycle. Higher specific illumination enables a reduction in the required exposure duty cycle and a corresponding increase in image resolution along the media transport axis. Narrow band illumination of the media also reduces light contributions from effectively adjacent image lines, thereby reducing line blending and further increasing effective imager resolution along the media transport axis. Collectively, up to a two-fold resolution improvement, relative to conventional systems, may be realized. Image resolution improvement in both the transport and transverse axises is also obtained as a result of the reduced color spectrum refraction variance due to the substantially monochromatic spectrum of the source light strip. The manufactured cost of the lens is also reduced.

Still another advantage of the present invention is that the light source is structurally stable and that the LED micro-strip is aligned and physically matches the CCD imager configuration. The mechanically fixed structure of the LED micro-strip results in less sensitivity to vibration, particularly relative to an incandescent filament. The fixed, multiple emitter element array structure of the LED micro-strip and associated diffuser element improves the quality of light dispersion and avoids the potential for hot or cold illumination spots. The narrow cross section of the LED micro-strip enables the efficient projection of illumination through the active area of the microfilm and on to the CCD imager.

Yet another advantage of the present invention is that the light source substantially improves the controlled delivery of narrow width illumination to the diffuser and further maintains a narrow width delivery of the randomized illumination to and through the microfilm. An optional, generally preferred, cylindrical lens is placed in the optical path to efficiently concentrate narrow width illumination onto the diffuser element. A narrow reflective channel is provided to restrain illumination dispersal from the diffuser while additionally allowing the diffuser to be placed outside of the maximum depth of field of the lens observable by the camera.

A still further advantage of the present invention is that the LED light source is constructed as a compact unitized structure containing a fully solid-state active light emitter. The light source structure includes an integral heat sink well sufficient to avoid any thermal distortion of the LED micro-strip. The combined use of solid-state emitters and strobed control results in power consumption and heat generation levels that are one-tenth that of conventional incandescent light sources. The solid-state LED micro-strip has a rated mean-time-between-failure of more than about 50 times that of conventional incandescent light sources. While not expected to fail within the normal operating lifetime of a microfilm scanner system, the light source is a readily serviceable and maintainable component.

### BRIEF DESCRIPTION OF THE DRAWINGS

FIG. 1A illustrates a preferred microfilm media imaging and transport system embodiment constructed generally in accordance with the present invention.

FIG. 1B provides a detail view representative of a microfilm media containing a document and illustrative scan lines appropriate for use in conjunction with a preferred embodiment with the present invention.

FIG. 2 is a graph showing the representative association of camera, illumination, and scan-line timings as used in a preferred embodiment of the present invention.

FIG. 3 provides an exploded perspective view of a light source system as implemented in a preferred embodiment of the present invention.

FIG. 4 provides a perspective view of an LED micro-strip constructed and mounted on a thermal substrate as implemented in a preferred embodiment of the present invention.

FIG. 5A is a cross-section construction detail through an end portion of the LED micro-strip of FIG. 4 as implemented in a preferred embodiment of the present invention.

FIG. 5B is a top-view detail of the LED micro-strip of FIG. 4 showing a first alternate LED element array layout as implemented in an alternate preferred embodiment of the present invention.

FIG. 5C is a top-view detail of the LED micro-strip of FIG. 4 showing a second alternate LED element array layout as implemented in an alternate preferred embodiment of the present invention.

FIG. 5D is a cross-section construction detail through the LED micro-strip of FIG. 5c illustrating a preferred convergent orientation of the LED element array as implemented in an alternate preferred embodiment of the present invention.

FIG. 6 is a cross-section construction detail through the light source system of FIG. 3 illustrating the light path established in a preferred embodiment of the present invention.

FIG. 7 provides a schematic of a driver circuit utilized in a preferred embodiment of the present invention.

FIG. 8 is a circuit schematic of the LED micro-strip as utilized in a preferred embodiment of the present invention.

FIG. 9 is a software block diagram illustrating the principal control flows utilized in managing operation of the light source system in conjunction with a film transport path as implemented in a preferred embodiment of the present invention.

### DETAILED DESCRIPTION OF THE INVENTION

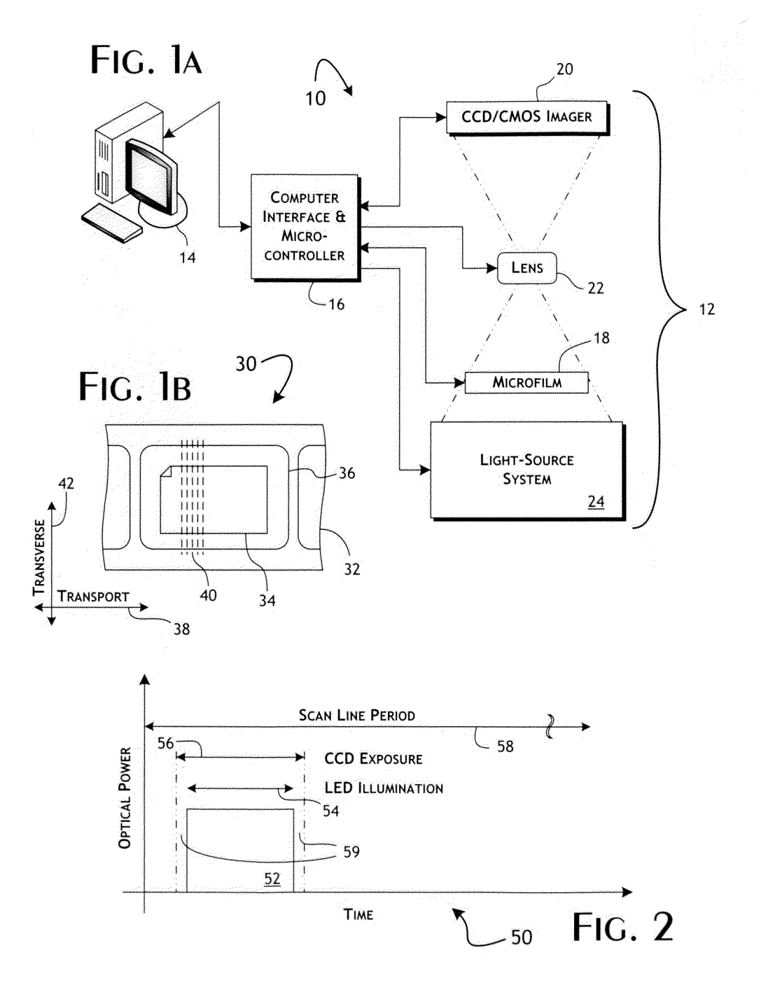

The present invention provides a high-intensity, strobed light source appropriate for use in high-speed scan imaging systems, such as the continuous scan microfilm imaging system 10 shown in FIG. 1A. The imaging system 10 preferably includes an optomechanical imaging system 12, an imaging system management computer 14, and a microprocessor-based controller 16 suitable for real-time control applications. The imaging system 12 preferably includes a continuous microfilm media transport system 18, a line scan-type CCD or CMOS imaging camera, or imager, and objective lens 22. A preferred mechanical system configuration, including feedback managed speed controller, is described in High-Speed Continuous Linear Film Transport System, U.S. Pat. No. 7,093,939 issued Aug. 22, 2006 to Breish et al., and which is hereby incorporated by reference. The light source 24 of the present invention is positioned to project a high-intensity light beam through the microfilm media to the imager 20, subject to focusing by the lens 22. In alternate embodiments of the present invention, the light source 24 may be positioned to provide reflected, rather than transmissive illumination to the imager 20 by positioning the imager 20 and light source 24 on the same side of the microfilm media.

A representative section 30 of microfilm media 32 is shown in FIG. 1B. As used in relation to preferred embodiments of the present invention, the media 32 contains a succession of frames 34. Each frame 34 contains a micro-image of a document 36 containing any combination of text and images. The controller 16 managed continuous scan microfilm transport system 18 moves the microfilm media 32 at a programmed speed along a transport axis 38. Subject to media speed and user programmed resolution requirements, the controller 16 operates to periodically acquire successive scan line images 40 generally along a transverse axis 42.

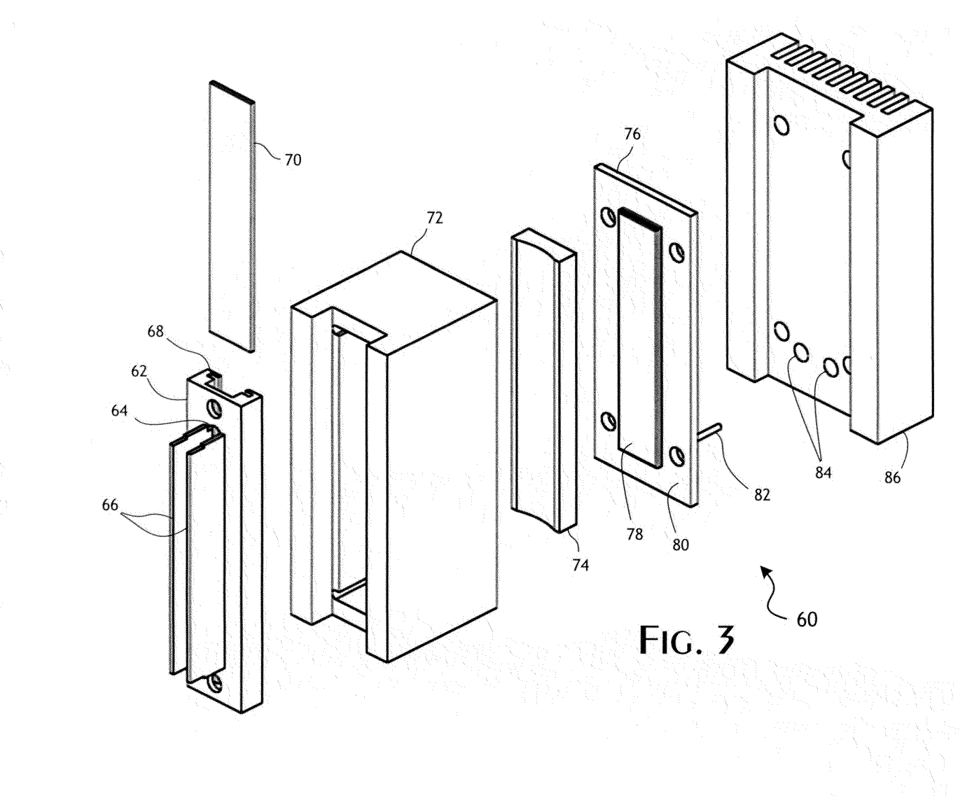

Referring to the timing graph 50 presented in FIG. 2, the light source 24 is preferably operated by the controller 16 in a periodic, or strobed, mode generally synchronous with the exposure period of the imager 20. In the preferred embodiments, illumination, corresponding to emitted optical power 52, is generated by the application of controlled current to an LED-based light emitter for an LED illumination period 54. The illumination period 54 is preferably synchronous with and generally symmetrically within the CCD exposure period 56 established by the controller 16. The timing guard-bands 59 defined between the illumination period 54 and exposure period 56 are on the order of about one to ten microseconds and preferably two microseconds. Although the beginning and duration of the exposure period 56 may be precisely commanded to the imager 20, the beginning and ending of the actual CCD exposure cycle internal to the imager 20 will be somewhat asynchronous. The guard bands 59 are preferred to allow for the timing variation. Negative guard-bands are not preferred generally as a waste of optical power. Excessive positive guard-bands are not preferred as potentially allowing stray or ambient light accumulation, resulting in degradation in the acquired image.

The exposure period 56, for the preferred embodiments of the present invention, is set by the controller 16 to about ten percent of the scan line period 58, defined as equal to the interval between the successive scan line images 40. Increasing the exposure period 56 to scan line period 58 ratio results in an effective blending of adjacent lines due to the motion of the microfilm media and thereby decreases the effective resolution of the imager 20 in the transport axis 38. Thus, lower ratios are generally preferred. With decreasing ratios, however, the optical power 52 must be proportionally increased to enable adequate illumination capture by the imager 20. Consequently, a ratio of about 10% is currently preferred. Ratios upwards of about 30% can be used, generally at decreased media transport speeds, where lower resolutions are acceptable.

An exploded view 60 of a preferred embodiment of the light source 24 is shown in FIG. 3. An exit light guide 62 is preferably constructed from machined aluminum to have a light channel opening 64 that extends fully through the light guide 62. In the currently preferred embodiment, the light channel opening 64 is 1.625 inches by 0.125 inches. The light channel opening 64 is bordered by guide flanges 66 that extend outwards, in the currently preferred embodiment, for 0.3125 inches at a constant separation of 0.125 inches to define an extended light guide channel. A slot 68 is provided in the exit light guide 62 to receive a diffuser plate 70 positioned substantially perpendicular to the extended light guide channel. Internal surfaces, generally defined as those that are exposed to light source 24 generated light, are polished to about 90% reflectivity.

The exit light guide 62 fits within a light source body 72, also preferably fabricated from machined aluminum. The overall dimensions of the light source body 72 are 2.25 inches (length) by 0.875 inches (width) by 1.0 inches (height) in the currently preferred embodiment. In embodiments where a preferably rectangular form cylindrical concentrator 74 is utilized, a ledge within the internal cavity of the body 72 provides a retention surface against which the concentrator 74 is positioned so as to be substantial perpendicular to the extended light guide channel. In these preferred embodiments, the concentrator 74 has a length of 1.984 inches, width of 0.438 inches, thickness of 0.156 inches, and a focal length of 0.5 inches.

A light source assembly 76 is preferably constructed from an LED micro-strip assembly 78 mounted to an aluminum plate 80. Electrical connections 82 (one shown) to the micro-strip assembly 78 extend through access vias (not shown) in the plate 80 and corresponding access vias 84 in a heat sink block 86. In the preferred embodiments, the plate 80 mounts flush to the bottom of the light source body 72 and to the corresponding surface of the heat sink block 86. The currently preferred overall dimensions of the heat sink block 86 are 2.25 inches (length), 1.375 inches (width), and 0.5 inches (height) as constructed from machined aluminum. The fully assembled dimensions of 2.25 inches (length), 1.375 inches (width), and 1.75 inches (height) represents, in comparison to conventional incandescent light sources, a highly compact, unitized, and rugged light source 24.

A perspective view of the preferred light source assembly 76 is shown in FIG. 4. The micro-strip assembly 78 preferably contains a linear array of surface mounted LED elements 92 thermally coupled through the layers of the micro-strip assembly 78 and plate 80 ultimately to the heat sink block 86. The LED elements are preferably oriented as a single linear array aligned to a center line of the micro-strip assembly 78 and light source assembly 76. The single linear array configuration is preferred as most closely matching the orientation and illumination requirements of the imager 20. The center to center spacing of the LED elements is preferably chosen so that the LEDs are sufficiently close to avoid imaging hot spots. The number of LEDs is preferably chosen as sufficient to cover the effective optical area observable by the imager 20 with insignificant illumination intensity drop-off at or near the ends of the optical area. In the presently preferred embodiments, an optically active emitter area of about 1.662 inches in length is achieved by using a linear array of twenty-eight LEDs 102 mounted on about 0.060 inch centers and aligned on a centerline to within a tolerance of about ±0.010 inches. The LED elements are electrically connected as seven parallel sets of four serially connected LEDs. The terminal LED anode and cathode connections are routed to the electrical connections 82, 82′.

A construction detail 100 of the light source assembly 76 is shown in FIG. 5. As shown, a plate 80 provides a thermal and mechanical substrate for the micro-strip assembly 78. LEDs 102 are surface mounted on a high thermal conductivity beryllium oxide (BeO) board 104. An optically transparent epoxy coating 106 is preferably applied over the LEDs 102. In the presently preferred embodiments, the LEDs 102 are part number OD-1914, manufactured by Opto Diode Corporation, Newbury Park, Calif. These and equivalently preferred LEDs have a narrow emissions band, centered close to the optimal response frequency of the imager 20, which is about 680 nanometers (nm), and limited IR emissions to avoid the potential for imager 20 pixel-to-pixel bleeding. The narrow emissions band preference also reduces the color correction requirement and corresponding cost of the lens 22.

While the single linear array of surface mounted LED elements 92 is preferred, multiple arrays of varying configurations can also be used. A top-view detail of an alternate LED array configuration 92′ is shown in FIG. 5B. As shown, a close pack arrangement of LED elements 102 may be desired to provide a closer effective center to center spacing relative to the length of the optically active emitter area, reducing the potential for imaged hot spots and significantly increasing the available optical power that can be generated by the LED micro-strip 78.

Another LED array configuration 92″ is shown in FIG. 5c. Three parallel arrays of LEDs 102 can be utilized to further increase the available optical power of the LED micro-strip 78, reducing the necessary exposure period of the imager 20, and thereby enabling operation of the optomechanical imaging system 12 at media transport speeds of 20 inches per second if not well above. As generally shown in FIG. 5D, the outer parallel arrays of the LED array configuration 92″ may be angled so that the centerline illumination from these LEDs 102 converge at a distance above the LED micro-strip 78 generally corresponding to a point just beyond the diffuser plate 70, subject to the presence of the cylindrical concentrator 74.

Alternately, the LED array configuration 92″ may be used to generate red, green, and blue (RGB) illumination preferably by implementing a center blue and outer red and green linear arrays of LEDs 102. By operating the three linear arrays in non-overlapping succession synchronous with three exposure periods 56 occurring during each scan line period 58, RGB images of the documents 34 can be acquired. Power levels through the three linear arrays, alternately or in combination with differences in exposure periods 56, can be individually tailored to the illumination efficiency of the implementing red, blue, or green LEDs 102 as necessary to achieve color balance. Preferably, transport speed would be constrained such that the ratio of the longest of the three exposure periods 56 relative to the scan line period 58 would be less than about 30% so as to limit line-scan blending and realize an acceptable image quality.

A section 110 through the preferred assembled light source 24 is shown in FIG. 6. The illumination light path from the LEDs 102 initially corresponds to the light dispersion range of the LEDs 102. In the preferred embodiments, the dispersion angle 112 is about 45 degrees from the perpendicular. The lower surface of the cylindrical concentrator 74 is generally positioned to directly receive the light output from the LEDs 102. The inner cavity surfaces 114 are again preferably polished to 90% reflectivity to minimize optical power loss. Light transmitted by the cylindrical concentrator 74 is preferably focused 116 at a point above the diffuser plate 70, generally as shown. In the preferred embodiments of the present invention, the light incident on the lower surface of the diffuser plate 70 has a width 118 of about 0.045 inches.

In the presently preferred embodiments of the present invention, the diffusion plate 70 is a 30° by 30° random angular diffuser. While the light dispersed from the diffusion plate 70 is directionally randomized, the dispersal pattern is sufficiently narrow that a majority of the dispersed light directly exits through the light channel opening 64 and remains within the width 118 until incident on the media 32 within the active area 120. A portion of the light dispersed from the diffusion plate 70 is desirably incident on the interior surfaces of the guide flanges 66. The polished interior surfaces generally constrain the light source illumination to within an effective active area 120 on the microfilm media 32. The greater angle of incidence on the media 32, relative to light directly incident within the width 118 is desirable for illuminating scratches and other imperfections in the surfaces of the media 32, making them less observable by the imager 20. A diffusion plate 70 with in-plane asymmetrical X-Y diffusion properties can be used to reduce or increase the portion of light transmitted by the diffusion plate 70 that is indirectly incident on the media 32 within the active area 120.

In the preferred embodiments, the guide flanges 66 are preferably positioned to within about 0.1 inches of the microfilm media 32, with closer being generally preferred to minimize unconstrained dispersal of the incident illumination. A distance of up to about 0.25 inches is likely acceptable. The height of the guide flanges 66 are preferably chosen, in combination with the guide flange 66 to microfilm media 32 gap, as sufficient to place the upper surface diffuser plate 70 outside of the maximum depth of field resolvable by the imager 20.

Use of the cylindrical concentrator 74 is preferred to maximize the optical power that is delivered into the center width 118 of the active area 120. Although the preferred diffusion plate 70 provides for a 30° dispersal along the transport axis 38, the high concentration of light within the width 118 on the surface of the diffusion plate 70 results in a very high percentage of the total light output of the LEDs 102 being delivered within a very narrow central band of the active area 120, generally corresponding to the width 118. Use of the cylindrical concentrator 74 is not, however, required. In initial preferred embodiments of the present invention, the cylindrical concentrator 74 and positioning ledges 122 are omitted. The horizontal spacing between the internal cavity surfaces 124 is made the some as surfaces 114 and similarly polished. The total light output of the LEDs 102 will be eventually incident on the diffuser plate 70 and substantially all will be transmitted through the light channel opening 64. However, the resulting projected light intensity will not be uniform across the width of the active area 120. Since the illumination output of the LEDs 102 is not constant over the dispersion angle 112, but is rather substantially greater along the perpendicular, the illumination incident on the media 32 will be greatest, as is preferred, within the width 118 of the active area 120.

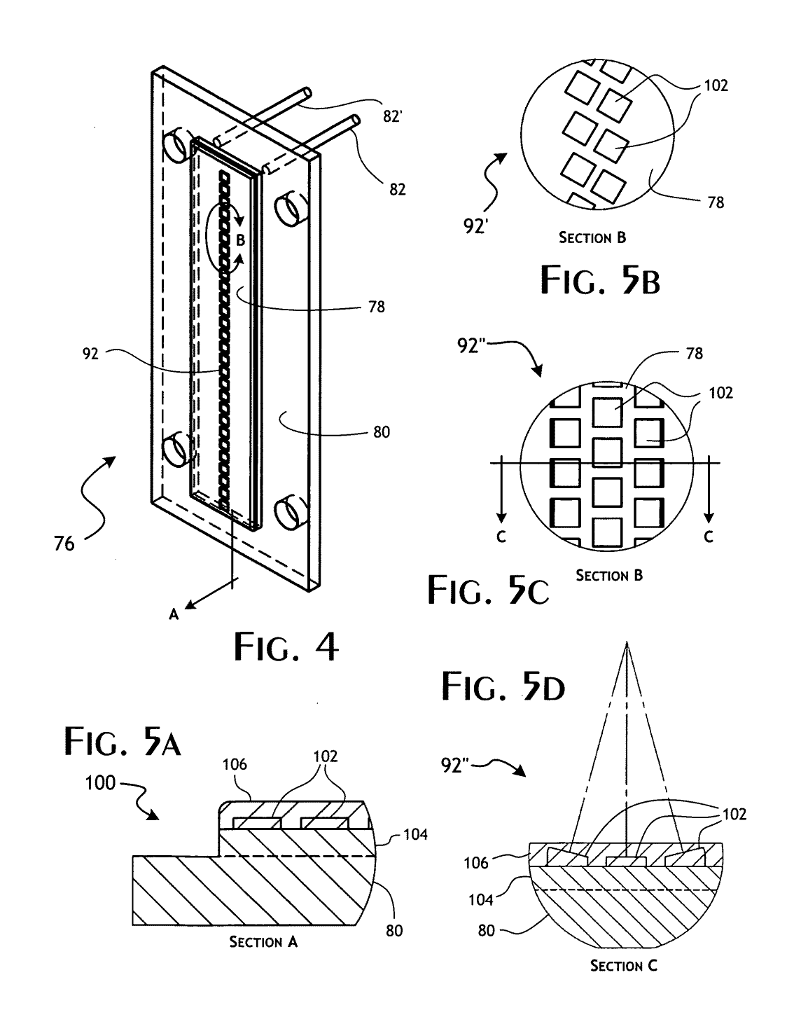

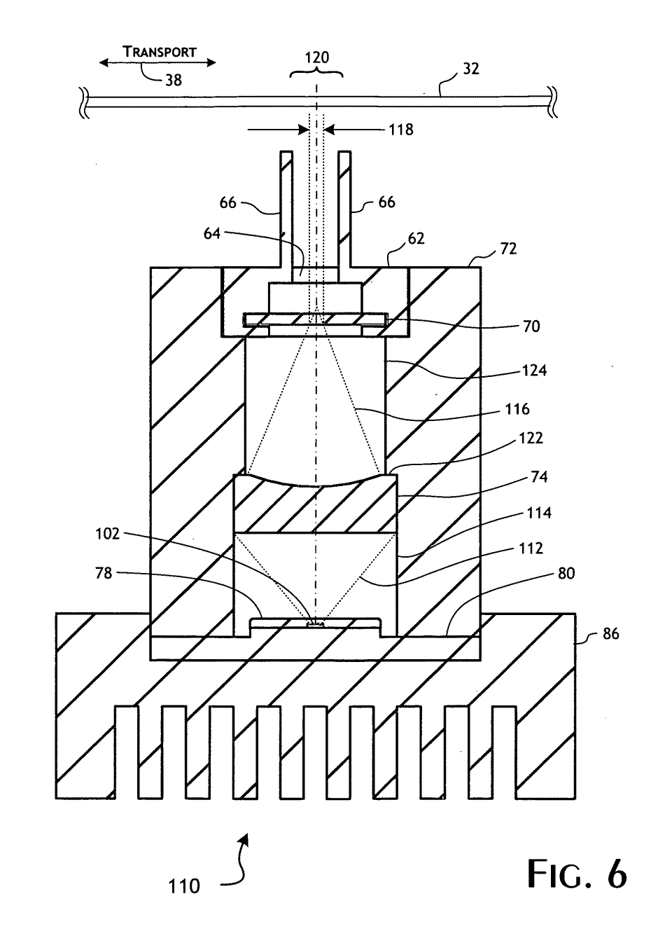

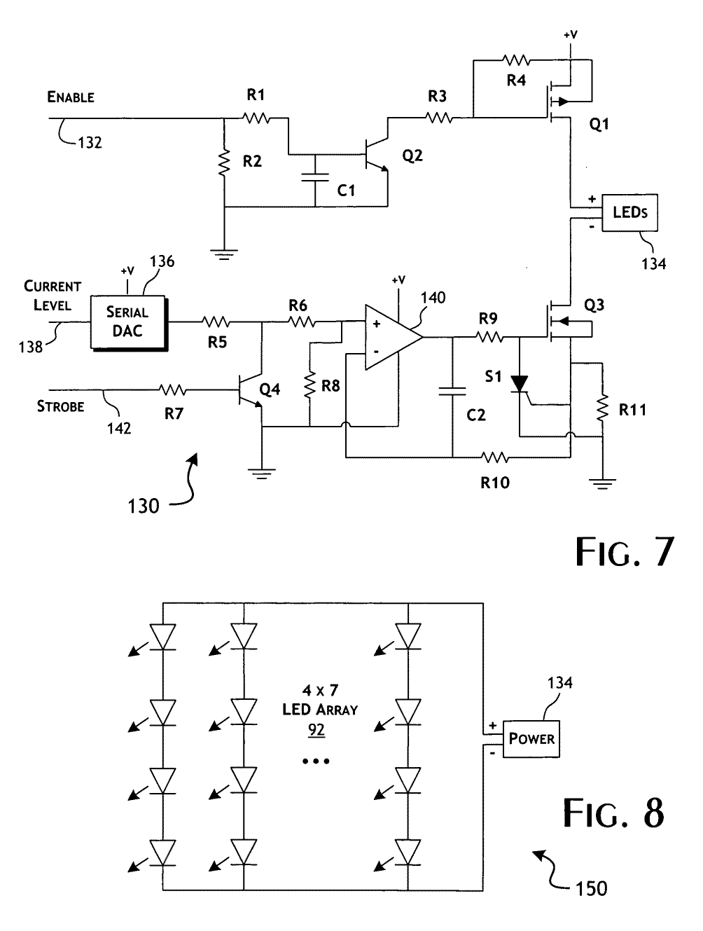

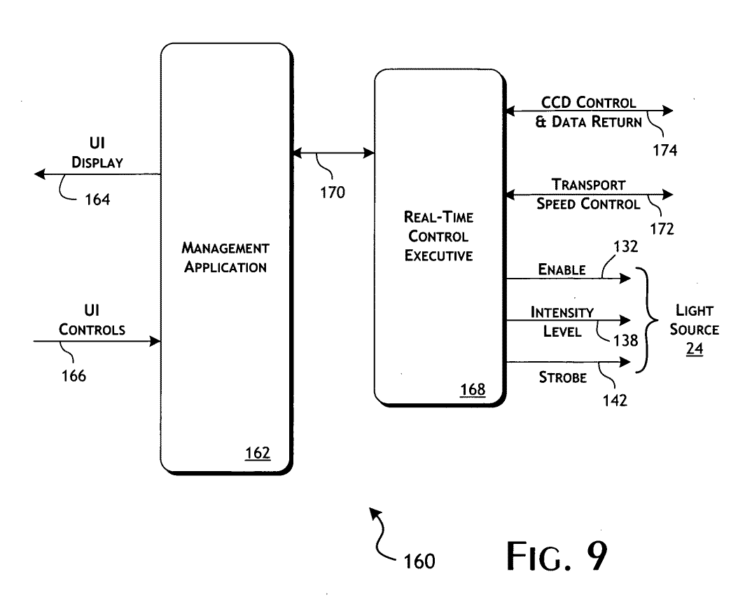

The micro-controller 16 preferably includes a LED micro-strip driver circuit 130, as shown in FIG. 7. In the preferred embodiments, the driver circuit 130 provides three programmable component controls, including enable, current level, and pulse width, or strobe, control. As implemented in a preferred embodiment, an enable line, programmatically driven by the micro-controller 16, controls operation of a high-current P-channel MOSFET transistor Q1 through selective operation of a gating NPN transistor Q2. Current will be allowed to flow into the anode terminal of the LED array connector 134 when the enable line is set high. The current path is completed through a high-current, low input capacitance, N-channel MOSFET transistor Q3 connected between the cathode terminal of the LED array connector 134 and a current sense resistor R11 through to ground.

A 12-bit serial digital to analog converter 136, driven from a serial output line 138 of the controller 16, is preferably used to set a selected current level through the transistor Q3. The output voltage level from the converter 136 is applied to the input of a voltage-follower configured operational amplifier 140. In operation, the amplifier acts to maintain a zero differential voltage between the converter 136 set input control voltage and a feedback voltage that is proportional to the current through the transistor Q3. The current level through transistor Q3 determines the illumination produced by the LED micro-strip 92 and can be selected empirically or analytically based on optical density and related microfilm media factors.

Pulse-width control of the illumination generated by the LED micro-strip 92 is defined by a strobe control signal programmatically driven on a strobe line 142. The strobe control signal controls an NPN transistor Q4 configured to force a zero current level state by grounding an input of the operational amplifier 140. The transistor Q3 preferably has a high-switching speed, allowing for quick on/off transitions of current through the LED micro-strip 92. A silicon controlled rectifier S1 is provided to protect against potentially damaging over-currents through the transistor Q3 and LED micro-strip 92 as a result of component failures. Preferred part values and manufacturer part numbers for the LED micro-strip driver circuit 130, as implemented in an initially preferred embodiment of the present invention are as follows:

| Part | Value | | Part | Value |
|---|---|---|---|---|
| R1, R3 | 100 | KΩ | Q1 | FQP27P06 |
| R2, R5, R6 | 1 | KΩ | Q2, Q4 | MMBT5089L |
| R4 | 470 | KΩ | Q3 | STP20NF06 |
| R7 | 2 | KΩ | C1 | 4.7 μF |
| R8 | 470 | Ω | C2 | 560 pF |
| R9 | 10 | Ω | | |
| R10 | 100 | Ω | | |

| | |
|---|---|
| R11 | 0.05 Ω(3 W) |

As generally shown in FIG. 8, the preferred configuration 150 of the LED micro-strip 92 is a four by seven array of LED elements. To drive the LED micro-strip 92, a source voltage of about eight Volts is provided to transistor Q1. For a scan line period 58 of about 50 microseconds, the strobe 142 control signal “on” period is about five to seven microseconds. The preferred LEDs 102 have a maximum current rating of 500 milliamps. In the preferred embodiments, the LED micro-strip 92 is operated at a current level of about 3.5 Amp average, 10 Amps instantaneous, to maintain LED junction temperatures below about 115° Celsius. This thermal requirement is readily met at throughout the operating range of the present invention, which is generally defined as continuous operation of the optomechanical imaging system 12 at greater than about 2,000 illumination cycles per second and illumination periods each of less than about 50 microseconds. Continuous operation at 36,000 illumination cycles per second and 2.8 microsecond illumination periods is well achieved.

In the preferred embodiments, operation of the imaging system 12 is controlled through a management application 162 executed on the computer system 14. The management application 162 presents a user interface display 164 representation of the state and operation of the imaging system 12 and, further, supports mouse and keyboard selectable system controls 166 to selectively enable and adjust operation of the imaging system 12. The management application issues commands to and receives data, specifically including buffered scan line data, from a real-time control executive 168 executed on the embedded micro-controller within the controller 16. The control executive 168 is connected through an interface circuit to the microfilm media transport system 18, imager 20 and lens 22. In particular, the control executive 168 responsible for performing 172 continuous motor speed control, using positional feedback signals, to maintain a commanded microfilm media transport speed through the transport system 18. Adjusted for actual microfilm media transport speed, the control executive 168 preferably operates the imager 20 to perform exposure cycles and return image line data 174. The enable and intensity level signals 132, 138 are set as commanded by the management application 162. The strobe control signal 142 is issued in concert with the performance of exposure cycles.

Thus, a compact, highly-efficient light source has been described. While the present invention has been described particularly with reference to a continuous microfilm line-scan system, the light source may be equally applicable in non-continuous and non-microfilm media applications. Further, the configuration of the LED micro-strip may be varied, specifically including physical layout of multiple linear arrays, as appropriate to achieve different levels of illumination. LED packaging and mounting technologies other than surface-mount may also be used. Suitable current level control and switching circuitry may also be implemented in various manners.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A light source for illuminating an image for a line-scan imager, said light source comprising:
a) an LED micro-strip emitter array mounted on a substrate and oriented to illuminate an active area of an image to be imaged by a line-scan imager; and
b) a control circuit coupled to said LED micro-strip emitter array to enable active emission of illumination by said LED micro-strip emitter array in response to a strobe control signal synchronized to an exposure cycle of said line-scan imager.

2. The light source of claim 1 wherein said strobe control signal is provided with a pulse-width of less than about 30% of the line-scan period of said line-scan imager.

3. The light source of claim 2 wherein said LED micro-strip emitter array includes a plurality of LEDs positioned in a linear array on said substrate, said light source further comprising:
a) a heat sink thermally coupled to said LED micro-strip emitter array; and
b) a housing covering said LED micro-strip emitter array, said housing including an aperture opposite said LED micro-strip emitter array so at to permit the transfer of illumination from said LED micro-strip emitter array to said active area.

4. The light source of claim 3 further comprising an optical concentrator, said optical concentrator being mounted within said housing and in the optical path between said LED micro-strip emitter array and said active area, said optical concentrator focusing the illumination emitted by said LED micro-strip emitter array into a region within said active area aligned with said line-scan imager.

5. The light source of claim 4 further comprising a diffuser plate, said diffuser plate being mounted within said housing and in the optical path between said optical concentrator and said active area, said diffuser plate operative to directionally randomize incident illumination transmitted through said diffuser plate, said optical concentrator operative to focus the illumination emitted by said LED micro-strip emitter array into a strip of predetermined width on a surface of said diffuser plate, said strip being aligned with said line-scan imager.

6. The light source of claim 5 wherein said housing includes an external flange positioned at an edge of said aperture operative as a light path guide for a portion of the optical path between said aperture and said active area.

7. The light source of claim 6 wherein a surface of said external flange is polished so as to be substantially reflective to incident illumination and wherein the extent of said external flange away from said active area is sufficient to position said diffuser plate outside of the depth of field of said line-scan imager.

8. The light source of claim 7 wherein said optical concentrator is a cylindrical lens aligned with said LED micro-strip emitter array.

9. The light source of claim 2 further comprising:
a) a diffuser plate mounted within said housing and in the optical path between said LED micro-strip emitter array and said active area, said diffuser plate operative to directionally randomize incident illumination transmitted through said diffuser plate; and
b) an external flange positioned at an edge of said aperture operative as a light path guide for a portion of the optical path between said aperture and said active area, a surface of said external flange being polished so as to be substantially reflective to incident illumination, wherein the extent of said external flange towards said active area is operative to constrain the illumination transmitted through said diffuser plate to said active area, and wherein the extent of said external flange away from said active area is sufficient to position said diffuser plate outside of the depth of field of said line-scan imager.

10. A microfilm imaging system comprising:
a) a microfilm transport system providing for the high-speed translation of a microfilm media through an active imaging area;
b) a line imaging camera system, including a focusing lens, positioned to acquire, within an exposure period, a line image of said microfilm media within said active imaging area, said line imaging camera being operable in exposure periods to acquire a line image and successive said line images being acquired during a plurality of scan line periods, each said exposure period occurring within a corresponding said scan line period, wherein each said exposure period is less than about 50 μseconds in duration;
c) a light source oriented to illuminate, for the duration of an illumination period, said microfilm media within said active area, wherein said light source includes an LED emitter element optically oriented towards said line image, said light source being operable to emit illumination during each of a plurality of illumination periods; and
d) a controller coupled to said microfilm transport system, said line imaging camera system, and said light source, said controller being operative to define said exposure period and align each said illumination period with a corresponding exposure period.

11. The microfilm imaging system of claim 10 wherein said LED emitter element comprises an LED micro-strip including an array of LEDs mounted on a substrate in sufficient mutual proximity to provide substantially uniform illumination across at least one axis of said active area.

12. The microfilm imaging system of claim 11 wherein said plurality of LEDs are aligned as a linear array.

13. The microfilm imaging system of claim 12 further comprising:
a) a heat sink thermally coupled to said plurality of LEDs through said substrate; and
b) a housing coupled to said LED micro-strip, said housing having an opening providing an optical path for illumination emitted from said plurality of LEDs to reach said active area; and
c) a diffuser plate mounted within said housing in said optical path, wherein an interior surface of said housing is polished so as to be substantially reflective to the illumination emitted by said plurality of LEDs, whereby substantially all illumination emitted by said plurality of LEDs is transmitted through said diffuser plate and through said opening.

14. The microfilm imaging system of claim 12 further comprising an optical concentrator provided between said array of LEDs and said active area, said optical concentrator operative to concentrate illumination emitted by said array of LEDs across said at least one axis of said active area.

15. The microfilm imaging system of claim 14 further comprising:
a) a heat sink thermally coupled to said plurality of LEDs through said substrate; and
b) a housing coupled to said LED micro-strip, said housing having an opening providing an optical path for illumination emitted from said plurality of LEDs to reach said active area; and
c) a diffuser plate mounted within said housing in said optical path, said optical concentrator being mounted with said housing in said optical path to focus the illumination emitted from said plurality LEDs onto a surface strip of said diffuser plate aligned with said at least one axis of said active area.

16. The microfilm imaging system of claim 15 wherein said plurality of LEDs have a center emission frequency of about 625 nanometers.

17. The microfilm imaging system of claim 16 wherein said plurality of LEDs are arranged as a linear array of LEDs.

18. A light source suitable for use in a continuous transport microfilm imaging system, wherein a line camera acquires successive images within an active illumination area established generally across a width of a microfilm media transverse to the transport direction of said microfilm media, said light source comprising:
a) a light source housing having a light output opening, wherein said light output opening is further defined by a narrow width light transfer channel corresponding to said narrow width active illumination area of said microfilm media;
b) an LED emitter element thermally coupled to a heat sink and mounted within said light source housing;
c) an optical diffusion plate mounted within said light source housing in an optical path extending between said light output opening and said LED emitter element, said optical diffusion plate providing for a randomized directional distribution of light emitted by said LED emitter element along said optical path constrained by said light transfer channel.

19. The light source of claim 18 further comprising a controller coupled to said LED emitter element, said controller being operative in combination with said line camera to enable the emission of light by said LED emitter element within an exposure period of said line camera.

20. The light source of claim 19 said controller enables emission of light by said LED emitter element for less than about 30% of the period of successive image exposures by said line camera.
